(19) United States
(12) Patent Application Publication
(10) Pub. No.: US 2026/0138553 A1
(43) Pub. Date: May 21, 2026

(54) VEHICLE SEAT PROVIDED WITH AN ON-BOARD SAFETY SYSTEM

(71) Applicants: RENAULT s.a.s., BOULOGNE BILLANCOURT (FR); Nissan Motor Co., Ltd., KANAGAWA (JP)

(72) Inventors: Loic BEZEAULT, LE CHESNAY (FR); Gregor HEWAK, VAUREAL (FR)

(21) Appl. No.: 18/686,230

(22) PCT Filed: Jul. 21, 2022
(86) PCT No.: PCT/EP2022/070556

§ 371 Date: Feb. 3, 2026

(30) Foreign Application Priority Data
Aug. 26, 2021 (FR) FR2108953

(51) Int. Cl. B60R 21/207; B60N 2/02; B60R 21/231; B60R 21/2334; B60R 21/2338; B60R 21/235

(52) U.S. Cl. CPC B60R 21/207; B60N 2/0276; B60R 21/2334; B60R 21/235; B60R 2021/23107; B60R 2021/23386; B60R 2021/23538

(57) ABSTRACT

A vehicle seat includes a backrest structure, a seat structure, and an airbag having two components placed on the sides of the seat on either side of a person sitting thereon. Each component of the airbag has an inflatable bag and at least one strap sewn onto the bag, and—the seat structure has, at each of its sides, an internal casing and an external casing with a space therebetween. The at least one strap of each component of the airbag is inserted into the space.

The invention relates to a vehicle seat provided with an on-board safety system.

In order to simplify the drafting, it is always assumed that the deployment of the airbag occurs only in the case of an accidental impact of the vehicle against an external object, which can for example be another vehicle. It will not therefore be specified systematically that the deployment of the airbag occurs only after an impact of the vehicle.

In order to well understand the positioning of the various parts involved in a seat according to the invention, the description is given assuming that the seat is placed in a vehicle and making reference to a direct orthonormal reference frame XYZ linked to said vehicle and in which X is a front-rear longitudinal axis of the vehicle oriented toward the rear, Y is a transverse axis oriented toward the right side of the vehicle and Z is a vertical axis directed upward.

Currently, the front airbag placed in the dashboard just in front of the passenger seat is highly restrictive because it occupies a significant space in said dashboard.

One solution that makes it possible to settle this space problem consists in directly and totally transferring this airbag into the passenger seat. Now, such a transfer requires that the new airbag to be placed in said seat:
has protection characteristics at least equivalent to those of the old passenger airbag placed in the dashboard,
is mounted precisely and rigorously in the passenger seat in order for it to be able to be deployed fluidly in the desired configuration, without an element already present in said seat hampering or preventing the deployment of this new airbag.

Some existing seats already comprise simple airbags placed on each side of the seat complementing the one disposed in the dashboard, and therefore with a performance level that complements that of the airbag disposed in the dashboard.

Now, these airbags necessitate having a positioning of the seat that is predetermined with respect to the dashboard, which is a constraint in the case of autonomous vehicles, for which the seats of the occupying passengers are required to be displaced or pivoted with a great amplitude.

A seat according to the invention comprises a powerful airbag capable of effectively protecting an individual who would be seated on said seat, and the specific mounting of which in said seat allows a fluid and efficient deployment of said airbag.

The subject of the invention is a vehicle seat comprising a backrest structure, a seat base structure having a submarining prevention boss, and an airbag having two components placed on the sides of said seat on either side of an individual who would be seated thereon.

According to the invention:
each component of the airbag comprises an inflatable bag and at least one strap sewn onto said bag, said component being able to be deployed toward the front of the seat in the case of an impact of the vehicle, such that said components are brought to completely surround the individual,
said at least one strap of each component has a top fixing point in an upper zone of the backrest structure and a bottom fixing point for fixing to the submarining prevention boss of the seat base structure, and said at least one strap of each component runs along a side of the backrest structure and along a side of the seat base structure,
the seat base structure has, on each of its sides, an inner casing and an outer casing forming a passage between them, said at least one strap of each component of the airbag being inserted into said passage, said two casings constituting guiding tracks to allow said at least one strap and the inflatable bag to be deployed on the seat in the case of an impact of the vehicle.

The airbag implemented in a seat according to the invention comprises two components disposed on either side of an individual who would be seated on said seat, said two components being brought to be each deployed toward the front in the case of an impact of the vehicle to completely surround this individual. The particular feature of this airbag is that each of its components comprises an inflatable bag and at least one strap sewn onto this bag, said at least one strap making it possible:
to anchor the component of the airbag in the seat with a top fixing point in an upper zone of the backrest and with a bottom fixing point in a submarining prevention boss of the seat base,
to guide the deployment of the inflatable bag on the seat in order for the latter to ensure a good protection of the individual who would be seated on said seat.

Now, such an airbag must be mounted with a certain care in the seat, for it to be able to be deployed effectively around an individual would be seated on said seat. Incorporating this airbag in a seat according to the invention involves creating a passage on the two sides of the seat base structure by means of two casings, and in which said at least one strap of each component of the airbag would come to be positioned. Implementing these two casings makes it possible:
to hold the strap on the seat base structure in an isolated space that does not interfere with any other element of said seat base structure,
to create a deployment track oriented toward the front of the component of the airbag. Indeed, when the bag begins to be deployed, said at least one strap will exit from the passage created between the inner casing and the outer casing.

The passage formed between the inner casing and the outer casing is dimensioned as precisely as possible so as to ensure the insertion of the strap while minimizing the plays. In order to well understand the orientation of the passages created on each side of the seat base structure and assuming that the seat is mounted in the vehicle, the inner casing and the outer casing:
are substantially parallel and each extend along a longitudinal and vertical plane XZ of the vehicle,
define between them a passage extending along a longitudinal and vertical plane XZ of the vehicle,
are mounted on each of the two parallel edges of the seat base extending along a longitudinal and horizontal axis X of the vehicle.

Each outer casing closely follows the form of the inner casing so as to create between them a passage of small and constant width.

According to a possible feature of the invention, each component of the airbag comprises two straps which, when said component is mounted in said seat, are superposed. In this way, when each component of the airbag is stressed upon an impact of the vehicle, the two straps exit from the passage situated between the inner casing and the outer casing before separating from one another to allow a controlled deployment of the inflatable airbag toward the front, said deployment being guided by the two straps of the component concerned.

According to a possible feature of the invention, the two superposed straps of each component of the airbag are folded to substantially 90° in their passages between the backrest structure and the seat base structure. This prior folding is doubly necessary, because:
the direction of deployment chosen for the airbag in the seat will cancel this fold in order for the straps, once deployed, to become smooth again,
it allows the two superposed straps to strictly follow the path of the backrest and of the seat base, which are generally oriented at more than 90° to one another.

In other words, if this 90° fold were not produced, the deployment of the airbag would create a fold which could be damaging for the individual to be protected. The term “substantially 90°” means “90° plus or minus 10°”.

According to a possible feature of the invention, the inner casing on one side of the seat base structure has a recess in which is placed a first specific housing for housing a buckle thread of a safety belt. The presence of the airbag should not suppress the existing functions of the seat, notably that of a safety belt. The inner casing has been designed to take account of the presence of this safety belt. The straps of the airbag pass outside of the buckle thread and do not therefore interfere with said buckle thread and do not therefore risk skewing the operation of the safety belt.

According to a possible feature of the invention, the inner casing on the other side of the seat base structure has a recess in which is placed a second specific housing for housing an anchoring of the safety belt. The inner casing has been designed to take account of the presence of this safety belt. The straps of the airbag pass outside of the anchoring of the safety belt and do not interfere with said anchoring and do not therefore risk skewing the operation of the safety belt.

According to a possible feature of the invention, the backrest is adjustable in inclination by means of a mechanism, a front zone of the outer casing on one side of the seat base structure comprising a control handle linked to said mechanism by means of a wire and intended to drive said mechanism. Since the straps of a component of the airbag are brought to cover the backrest inclination mechanism, it is no longer possible to adjust the inclination of the backrest directly by means of a manipulation of this mechanism. To make it still possible to adjust the inclination of the backrest, the control handle of this mechanism had to be offset toward a front zone of the outer casing, in order for an individual seated on the seat to be able to easily manipulate said handle.

According to a possible feature of the invention, the backrest is mounted to pivot about an axis of rotation, the double strap of each component of the airbag being placed in the alignment of this axis of rotation. This way, by running in the alignment of this axis of rotation, the two straps of a component of the airbag will not prevent the backrest from being inclined.

According to a possible feature of the invention, the outer casing comprising the control handle controlling the inclination of the backrest comprises a control button intended to electrically activate a mechanism for raising the seat base structure.

Since the straps of a component of the airbag are made to interact with the seat base raising mechanism, said mechanism has been electrified so as to facilitate the adjusting of the raising of the seat base by means of a simple control button.

According to a possible feature of the invention, the inner casing and the outer casing on each side of the seat base structure are produced in a plastic material.

These casings will not make the seat significantly heavier, while making it possible to effectively guide the deployment of the airbag. Since these casings have no particular function in a normal vehicle running phases, there is no need to reinforce them unnecessarily.

According to a possible feature of the invention, a rigid angular member wire is placed on the seat base structure at the output of the inner casing and of the outer casing, the double strap forming a bend around this rigid wire so as to have a trajectory that is optimized upstream of said wire between the inner casing and the outer casing. This rigid wire makes it possible to ideally position the two superposed straps of a component of the airbag between the inner casing and the outer casing on one side of the seat base, notably in order for said straps to extend parallel to the passage formed between said inner casing and said outer casing.

A vehicle seat according to the invention offers the advantage of having an enveloping airbag intended to effectively replace a passenger airbag stowed in a dashboard, without having undergone a depthwise restructuring. Indeed, a shrewd mounting of the airbag on the seat by means of a restricted number of parts of simple design is sufficient to render said seat particularly efficient in terms of safety. The result thereof is that a seat according to the invention can directly and easily be produced from an existing seat, without requiring excessive mounting time and depthwise modifications of said seat. A seat according to the invention also has the advantage of being able to retain all its adjustments, such as for example the height of the seat base and the inclination of the backrest, despite the presence of a powerful airbag, as well as safety components, such as, for example, a safety belt.

A detailed description of a preferred embodiment of a seat according to the invention is given hereinbelow, reference being made to the following figures:

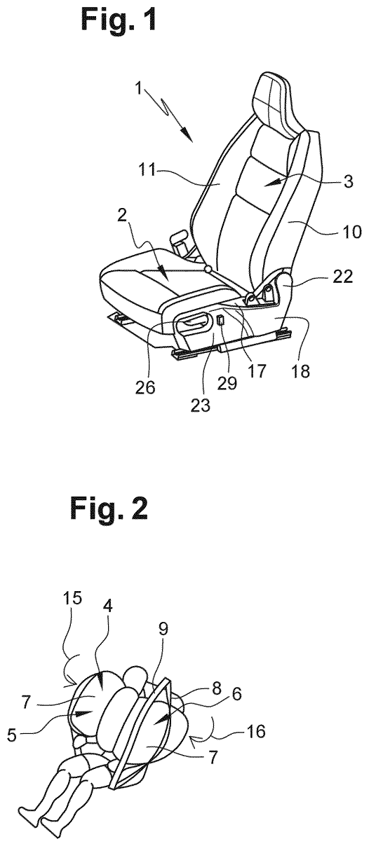

FIG. 1 represents a perspective view of a seat according to the invention,

FIG. 2 represents a perspective view of an airbag of a seat according to the invention, in a configuration deployed on the seat,

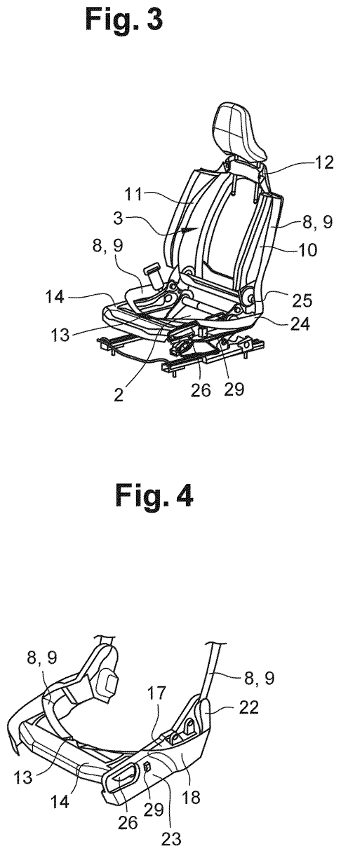

FIG. 3 represents a perspective view of the structure of the seat of FIG. 1,

FIG. 4 represents a partial perspective view of a seat base structure of a seat according to the invention,

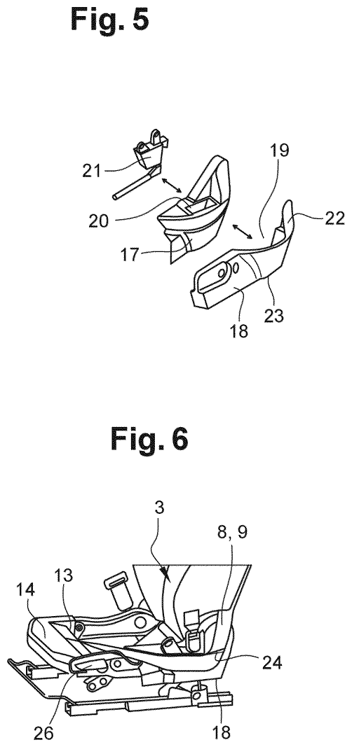

FIG. 5 represents an exploded perspective view of an inner casing and of an outer casing of a seat base structure of a seat according to the invention,

FIG. 6 represents a partial perspective view from another angle of the seat base structure of FIG. 4,

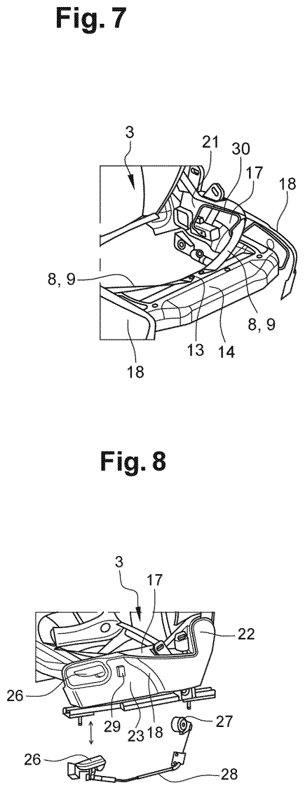

FIG. 7 represents a partial perspective view of a seat base structure of a seat according to the invention, showing an angular member wire for a strap of the airbag,

FIG. 8 represents a side view of a seat base structure of a seat according to the invention, comprising a handle for controlling the inclination of the backrest,

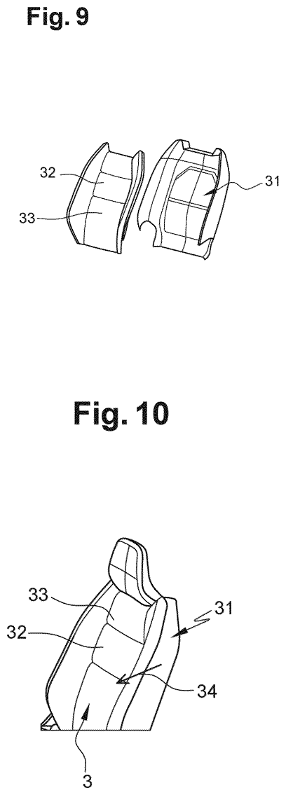

FIG. 9 represents an exploded perspective view of a backrest of a seat according to the invention,

FIG. 10 represents a perspective view of the assembled backrest of FIG. 9,

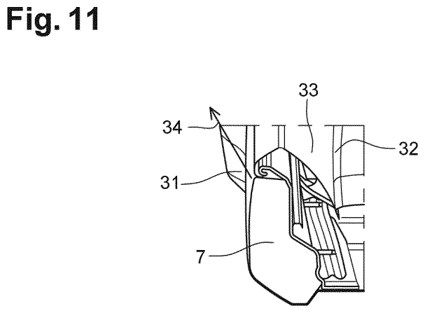

FIG. 11 represents a perspective view of a lateral zone of a backrest of a seat according to the invention,

Referring to FIG. 1, a seat 1 according to the invention is preferentially a passenger seat conventionally comprising a seat base 2 provided with a structure and a backrest 3 that is also provided with a structure.

Referring to FIG. 2, the particular feature of such a seat 1 is that it incorporates an airbag 4, intended to replace the passenger airbag usually housed in a dashboard of the vehicle, just in front of the passenger seat. Schematically, this airbag 4 comprises two separate components 5, 6, each comprising an inflatable bag 7 and two straps 8, 9 sewn onto this inflatable bag 7. The two components 5, 6 of this airbag 4 are stowed in the seat 1, on each side 10, 11 thereof, such that they are placed on either side of an individual who would be seated on said seat 1. In other words, these two components 5, 6 bracket an individual who would be seated on said seat 1 and are aligned along a transverse axis Y of the vehicle in which said seat 1 would be mounted. Since these two components 5, 6 are substantially identical, only one of these components 5, 6 will be described hereinafter in the description.

Referring to FIG. 3, when a component 5, 6 of the airbag 4 is stowed in the seat 1, the two straps 8, 9 are superposed and comprise a top fixing point in an upper and central zone 12 of the backrest structure 3, and a bottom fixing point in a central zone 13 of a submarining prevention boss 14 of the seat base 2. The inflatable bag 7 is inserted in one side of the backrest 3, so as not to be visible from the outside of said seat 1. The two superposed straps 8, 9 extend between their top fixing point and their bottom fixing point, by running on the sides of the backrest 3 and on the sides of the seat base 2 without ever being visible from the outside of said seat 1.

Referring to FIG. 2, in the case of an accidental impact of the vehicle against an external obstacle which can for example be another vehicle, the two components 5, 6 of the airbag 4 are deployed simultaneously toward the front as the two arrows 15, 16 indicate to come to completely encircle an individual who would be seated on the seat 1. Indeed, upon this deployment, the two inflated bags 7 of the two components 5, 6 come into continuity with one another to form a continuous protective bead around the individual. The deployment of each component 5, 6 of the airbag 4 is provoked by the inflation of the inflatable bag 7 and is guided by the two straps 8, 9 which are sewn onto said bag 7 and which are fixed both to the backrest structure 6 and to the seat base structure 2. When a component 5, 6 of the airbag 4 is deployed, the top fixing point and the bottom fixing point of the two straps 8, 9 remain unchanged, and continue to retain said two straps 8, 9. Once the individual has been completely surrounded by the two inflatable bags 7 of the two components 5, 6 of the airbag 4, he or she will be perfectly protected in all spatial directions.

In order for the two components 5, 6 of the airbag 4 to be able to perfectly serve their protection purpose, it is important to incorporate them well in the seat 1, so that they can be deployed fluidly and effectively in the desired direction, and without interfering with other elements of said seat. Indeed, it is essential for the incorporation of the two components 5, 6 of the airbag 4 in the seat 1 not to prevent, for example, the operation of a safety belt, or for elements of said seat 1 not to be able to hamper the deployment of said components 5, 6.

A seat 1 according to the invention has a seat base 2 specially configured to incorporate the two components 5, 6 of the airbag 4. The seat base structure 2 is schematically delimited by two longitudinal parallel edges extending along a longitudinal axis X of the vehicle, and by two transverse parallel edges extending along a transverse axis Y of said vehicle.

Referring to FIGS. 4 and 5, each longitudinal edge of the seat base structure 2 is embodied by an inner casing 17 and by an outer casing 18. The inner casing 17 and the outer casing 18 are parts of small thickness that are inscribed in a substantially vertical and longitudinal plane XZ of the vehicle. Along a transverse axis Y of the vehicle, the two outer casings 18 represent the two outermost parts of the seat base 2, each inner casing 17 being inserted between an outer casing 18 and a central zone of the seat base 2 on which an individual is intended to come to be seated. The outer casing 18 is elongate along a longitudinal axis X of the vehicle, and has a hollow zone 19, the inner casing 17 having a length less than that of the outer casing 18, the length being its dimension considered along a longitudinal axis X of the vehicle. The inner casing 17 has a curvature and is intended to come into contact with the wall of the outer casing 18 delimiting the hollow zone 19.

Referring to FIGS. 4 and 6, the inner casing 17, once it has been pressed against an inner surface of the outer casing 18, forms with said outer casing 18 a passage in which the two superposed straps 8, 9 of the component 5, 6 of the corresponding airbag 4 run. The inner casing 17 comprises an opening 20 intended to receive a specific housing 21 for housing either a safety belt buckle thread or an anchoring of said safety belt. In this way, the two superposed straps 8, 9 of the airbag 4, by running between the inner casing 17 and the outer casing 18, are external to said safety belt buckle thread and do not therefore risk interfering with the safety belt. Similarly, said safety belt will not prevent the two superposed straps 8, 9 of the airbag 4 from being deployed upon an impact of the vehicle against an external object.

Referring to FIGS. 1, 4, 5 and 8, the outer casing 18 has an end segment 22 extending at right angles to a main body 23 of said casing, said end segment 22 being located in the continuity of the backrest 3 and being intended to conceal the two superposed straps 8, 9 of the airbag 4, between said backrest 3 and the seat base 2 of the seat 1.

As FIGS. 3 and 6 show, between the backrest 3 and the seat base 2, the two superposed straps 8, 9 of the airbag 4 have a fold 24 at substantially 90°, that is to say at 90° plus or minus 10°. This prior fold at 90° is necessary to precisely prevent the appearance of a fold which could prove dangerous upon the deployment of the two superposed straps 8, 9 of the airbag 4. Indeed, the conditions of deployment of the two superposed straps 8, 9 of the airbag 4 in the seat 1 are such that the prior 90° fold will disappear, to leave space for airbag straps 8, 9 that are smooth and uniform, and therefore without the slightest fold, as illustrated in FIG. 2.

Referring to FIG. 3, like most of the backrests of existing vehicle seats, the backrest 3 of a seat 1 according to the invention is adjustable in inclination. It is mounted to be movable in rotation about an axis of rotation 25 extending along a transverse axis Y of the vehicle and placed in a lower zone of the backrest 3 structure. In their run on the sides of the backrest 3 and on the sides of the seat base 2, the two superposed straps 8, 9 of a component 5, 6 of the airbag 4 pass through this axis of rotation 25. In other words, if said axis of rotation 25 were artificially extended on each side, the two superposed straps 8, 9 of the airbag 4 would cross the artificial extensions of said axis of rotation 25. In this way, by passing through the axis of rotation 25 of the backrest 3, the two superposed straps 8, 9 of the airbag 4 do not prevent a rotation of said backrest 3 about said axis 25 to adjust its inclination. On the other hand, the two superposed straps 8, 9 of the airbag 4 cover a mechanism for rotating and positioning the backrest 3 usually placed in the extension of the axis of rotation 25 of the backrest 3, preventing any manipulation of this mechanism.

Referring to FIGS. 3, 4 and 8, in order to remedy this prevention, a control element 26 of this mechanism 27 has been created, then placed in a front zone of one of the two outer casings 18 of the seat base 2 of the seat 1. This control element is composed of a handle 26 extending by default along a longitudinal and horizontal axis X of the vehicle, said handle 26 linking the mechanism 27 for rotating and positioning the backrest 3 by means of a wire 28. This wire 28 is concealed by the outer casing 18, and a manual rotation of the control handle 26 exerts a tension on the wire 28 which acts directly on the mechanism 27 in order to be able to adjust the inclination of the backrest 3.

Similarly, the two superposed straps 8, 9 of the airbag 4 cover a mechanism for raising the seat base 2 and prevent any height adjustment of said seat base 2.

Referring to FIGS. 1, 3 and 4, this problem of access to the raising mechanism of the seat base 2 has been settled by adding to this mechanism an electric motor and by associating with this electric motor a control button 29. This control button is a pushbutton 29 which is fixed in the outer casing 18 supporting the control handle 26, said pushbutton 29 being placed behind said handle 26.

Referring to FIG. 7, a rigid angular member wire 30 is fixed to the seat base structure 2 inside an inner casing 17, so as to improve the positioning of the two superposed straps 8, 9 of the airbag 4 in the passage situated between the inner casing 17 and the outer casing 18. Indeed, the two superposed straps 8, 9 of the airbag 4 run around this rigid wire 30 by coming to bear against the latter, to form a bend, said rigid wire 30 straightening the two superposed straps 8, 9 of the airbag in order for them to be inserted optimally in the passage created between the inner casing 17 and the outer casing 18. In other words, this rigid wire 30 extends the straightness of the two superposed straps 8, 9 of the airbag 4 in the passage situated between the inner casing 17 and the outer casing 18.

Referring to FIGS. 9, 10 and 11, the inflatable bag 7 and a section of the superposed straps 8, 9 sewn onto said bag 7 are stowed in the backrest 3 of the seat 1. The claddings of the backrest 3 were modified to make it possible to rapidly free the two superposed straps 8, 9 and the bag 7 in the desired direction: the deployment must be done as fast as possible toward the front of the seat 1, to encompass the passenger and avoid contact with the zone of the center pillar of the body of the vehicle. To achieve this result, a rigid rear shell 31 covers a rear face of the backrest 3 and the two sides of said backrest 3, while keeping an elaborate finish with a foam 32 and a fabric 33. The interface between the foam 32, the fabric 33 and the shell 31 is produced with a part of the structure 34 of the seat 1. This interface makes it possible to free the superposed straps 8, 9 and the inflatable bag 7 and makes it possible to concentrate the deployment of said bag 7 and of said straps 8, 9 toward the front as indicated by the arrow 34 in FIGS. 10 and 11, to avoid a transverse deployment thereof. The shell 31 is separated under the effect of the pressure produced by the gases in the bag 7. The superposed straps 8, 9 are sewn onto an outer flank of the bag 7 and are therefore the first to be extracted from the backrest 3, even if they are linked to the bag 7.

1. A vehicle seat comprising:
a backrest structure,
a seat base structure having a submarining prevention boss, and
an airbag having two components placed on the sides of said seat on either side of an individual who would be seated thereon, wherein
each component of the airbag comprises an inflatable bag and at least one strap sewn onto said bag, said component being able to be deployed toward the front of the seat in the case of an impact of the vehicle, such that said components are made to completely surround the individual,
said at least one strap of each component has a top fixing point in an upper zone of the backrest structure and a bottom fixing point for fixing to the submarining prevention boss of the seat base structure, and said at least one strap of each component runs along a side of the backrest structure and along a side of the seat base structure,
the seat base structure has, on each of its sides, an inner casing and an outer casing forming between them a passage, said at least one strap of each component of the airbag being inserted into said passage, said two casings constituting guiding tracks to allow said at least one strap and the inflatable bag to be deployed on the seat in the case of an impact of the vehicle.

2. The vehicle seat as claimed in claim 1, wherein each component of the airbag comprises two straps which, when said component is mounted in said seat , are superposed.

3. The vehicle seat as claimed in claim 2, wherein the two superposed straps of each component of the airbag are folded to substantially 90°, in the passages thereof between the backrest structure and the seat base structure .

4. The vehicle seat as claimed in claim 2, wherein the inner casing on one side of the seat base structure has a recess in which is placed a first specific housing for housing a buckle thread of a safety belt.

5. The vehicle seat as claimed in claim 4, wherein the inner casing on the other side of the seat base structure has a recess in which is placed a second specific housing for housing an anchoring of the safety belt.

6. The vehicle seat as claimed in claim 2, wherein the backrest is adjustable in inclination by means of a mechanism, and in that a front zone of the outer casing on one side of the seat base structure comprises a control handle linked to said mechanism by means of a wire and intended to drive said mechanism.

7. The vehicle seat as claimed in claim 6, wherein the backrest is mounted to pivot about an axis of rotation, and in that the double strap of each component of the airbag is placed in the alignment of this axis of rotation.

8. The vehicle seat as claimed in claim 6, wherein the outer casing comprising the control handle controlling the inclination of the backrest comprises a control button intended to electrically activate a mechanism for raising the seat base structure.

9. The vehicle seat as claimed in claim 2, wherein the inner casing and the outer casing on each side of the seat base structure are produced in a plastic material.

10. The vehicle seat as claimed in claim 2, wherein a rigid angular member wire is placed on the seat base structure at the output of the inner casing and of the outer casing, and in that the double strap forms a bend around this rigid wire so as to have a trajectory that is optimized upstream of said wire between the inner casing and the outer casing.
